(19) United States
(12) Patent Application Publication
(10) Pub. No.: US 2012/0187189 A1
(43) Pub. Date: Jul. 26, 2012

(54) MULTIPLE DIRECTIONAL BARCODE SCANNER AND MULTIPLE SCANNING LIGHT SOURCE THEREOF

(75) Inventor: Kai-Yuan TIEN, Taipei (TW)

(73) Assignee: RIOTEC CO.,LTD.

(21) Appl. No.: 13/012,886

(22) Filed: Jan. 25, 2011

(51) Int. Cl. G06K 7/14; H04N 1/04

(52) U.S. Cl. 235/436; 358/475

(57) ABSTRACT

A multiple scanning light source for scanner includes a scanning pattern generating unit and a scanning pattern multiplying unit. The scanning pattern generating unit is for projecting a scanning pattern. The scanning pattern multiplying unit has a beamsplitter oblique to the projecting direction of the scanning pattern and a reflector substantially parallel to the beamsplitter. The scanning pattern is multiplied and projected toward a predetermined direction at intervals to form a scanning pattern array. In addition, a multiple directional barcode scanner having the above multiple scanning light source is also provided.

### BACKGROUND OF THE INVENTION

1. Field of the Invention

The present invention relates to a barcode scanner, in particular to a barcode scanner which is capable of generating a plurality of scan lines arranged in multiple directions without any rotary or swivel mechanism.

2. Description of Related Art

Barcode scanners are comprehensively adopted in convenient stores, supermarkets, or bookstores as means for identifying products and retrieving information of the products. They provide convenience in managing products and increase the counting speed. A barcode with identified information can be attached on a product, thus when the barcode is scanned by a light beam generated from the optical engine in the barcode scanner, an image sensor in the barcode scanner can be used to capture the barcode image, and a computer can be used to identify the code in the barcode image and to obtain the corresponding information such as price.

However, such a barcode could be randomly attached on different sides and different positions of a product, in order to find the barcode and scan it as soon as possible, the recent trend has migrated from the traditional single line scanning to the multiple line scanning in which each of the scanning lines has different direction. As FIG. 1 shows, a conventional multiple directional barcode scanning apparatus has a housing 10 having a laser installation base 11. A laser diode 12 is arranged in the laser installation base 11. A first chamber 112 is formed above the laser installation base 11 for accommodating a first mirror 13. A second chamber 113 is formed adjacent to the first chamber 112. A first opening 114 and a second opening 115 are respectively formed at the left side and the front side of the second chamber 113. A second mirror 14 and a third mirror 15 are both arranged in the second chamber 113. The laser beam from the laser diode 12 can propagate consecutively through the first mirror 13, the second mirror 14 and the third mirror 15 and then project out from the second opening 115. A rotary polygon mirror 16 is arranged at another side of the housing 10. A half-ring-shaped multiple mirror set 17 is arranged around the rotary polygon mirror 16. A motor (not shown) is connected to the bottom of the rotary polygon mirror 16 for rotating it with respect to the multiple mirror set 17.

After leaving from the second opening 115, the laser beam will be projected to one of the facets of the rotary polygon mirror 16, and then reflected to one of the mirrors of the multiple mirror set 17, and finally upwardly reflected to a barcode (not shown). Each of the facets of the polygon mirror 16 has different tilt angles. Each of the mirrors of the multiple mirror set 17 faces different directions. While the rotary polygon mirror 16 is rotated by the motor, the laser beam will scan the facets of the rotary polygon mirror 16 and then be projected to the mirrors of the multiple mirror set 17, so as to be projected upwardly and rapidly proceed scanning. The rapidly scanned laser beam spot will then form a scanning pattern 18 as FIG. 2. The scanning pattern 18 is composed of several scanning line sets. When a barcode is aligned with one of the scanning lines, the barcode can be effectively scanned.

However, since the scanning line sets of the scanning pattern 18 are obtained mainly due to the rotation of the rotary polygon mirror 16 with respect to the multiple mirror set 17. And the rotation is driven by the motor which will cause additional cost. With regard to reliability, the motor may raise the possibility of unexpected failure of the barcode scanner. Besides, the rotary polygon mirror 16 may make loud noise due to high-speed rotation while the barcode scanner is operating.

### SUMMARY OF THE INVENTION

The objective of the present invention is to provide a multiple scanning light source for scanner, which has no rotary or swivel mechanism to move beam spot to perform scanning and is capable of projecting a scanning pattern array having multiple scanning line sets in different directions.

Besides, the objective of the present invention is to provide a multiple directional barcode scanner having the above mentioned multiple scanning light source for scanner. The multiple scanning light source for scanner has no rotary or swivel mechanism to move beam spot to perform scanning and is capable of projecting a scanning pattern array having scanning line sets in different directions.

For achieving the mentioned objective, the present invention provides a multiple scanning light source for scanner including a scanning pattern generating unit and a scanning pattern multiplying unit. The scanning pattern generating unit is for projecting a scanning pattern. The scanning pattern multiplying unit has a beamsplitter oblique to the projecting direction of the scanning pattern and a reflector substantially parallel to the beamsplitter. The scanning pattern is multiplied and projected toward a predetermined direction at intervals to form a scanning pattern array.

For achieving the mentioned objective, the present invention provides a multiple directional barcode scanner for scanning a barcode. The multiple directional barcode scanner includes a scanning pattern generating unit, a scanning pattern multiplying unit and an image sensor. The scanning pattern generating unit is for projecting a scanning pattern. The scanning pattern multiplying unit has a beamsplitter oblique to the projecting direction of the scanning pattern and a reflector substantially parallel to the beamsplitter. The scanning pattern is multiplied and projected toward the barcode at intervals to form a scanning pattern array on the barcode. The image sensor is for capturing the image of the barcode.

### BRIEF DESCRIPTION OF THE DRAWINGS

FIG. 1 is schematic view of the conventional multiple directional barcode scanner;

FIG. 2 is a schematic view illustrating the scanning pattern of the conventional multiple directional barcode scanner;

FIG. 3 is a schematic view of the multiple directional barcode scanner of the present invention;

FIG. 4 is a schematic view of a scanning pattern generating unit of the present invention;

FIG. 5 is top schematic view of another embodiment of the scanning pattern generating unit;

FIG. 6 is a schematic view of the scanning pattern generated from the scanning pattern generating unit in FIG. 5;

FIG. 7A is a top schematic view of another embodiment of the scanning pattern generating unit;

FIG. 7B is a side schematic view of another embodiment of the scanning pattern generating unit;

FIG. 8 is a schematic view of the scanning pattern generated from the scanning pattern generating unit in FIG. 7;

FIG. 9A is a top schematic view of another embodiment of the scanning pattern generating unit;

FIG. 9B is a side schematic view of another embodiment of the scanning pattern generating unit;

FIG. 10 is a schematic view of the scanning pattern generated from the scanning pattern generating unit in FIG. 9; and

FIG. 11 is a schematic view of the scanning pattern multiplying unit of the present invention.

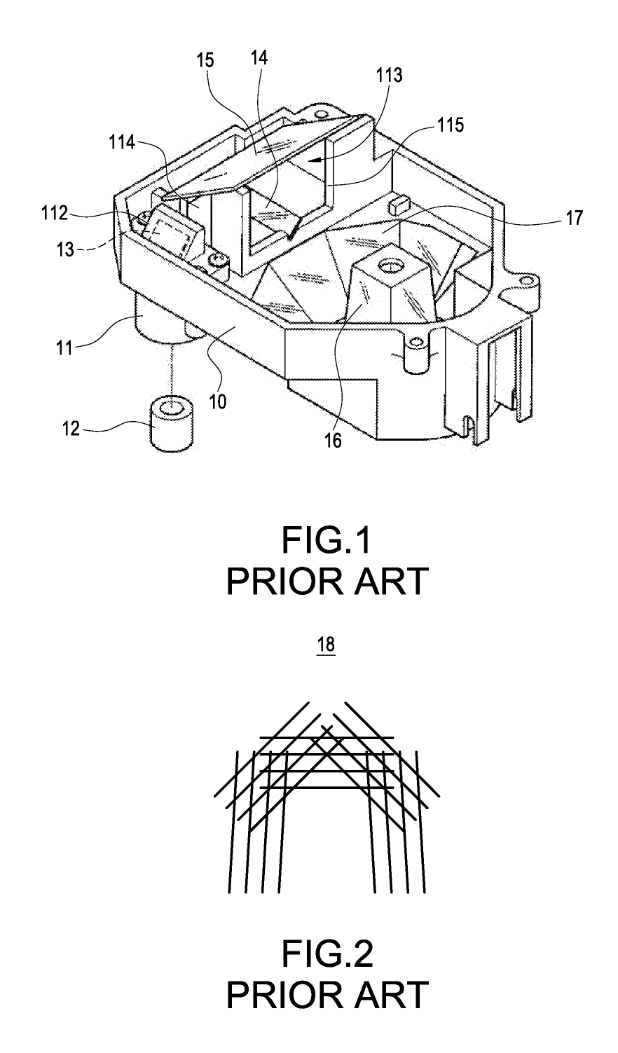

### DETAILED DESCRIPTION OF THE INVENTION

The technical characteristics and contents of the present invention will become apparent with the following detailed description accompanied with related drawings.

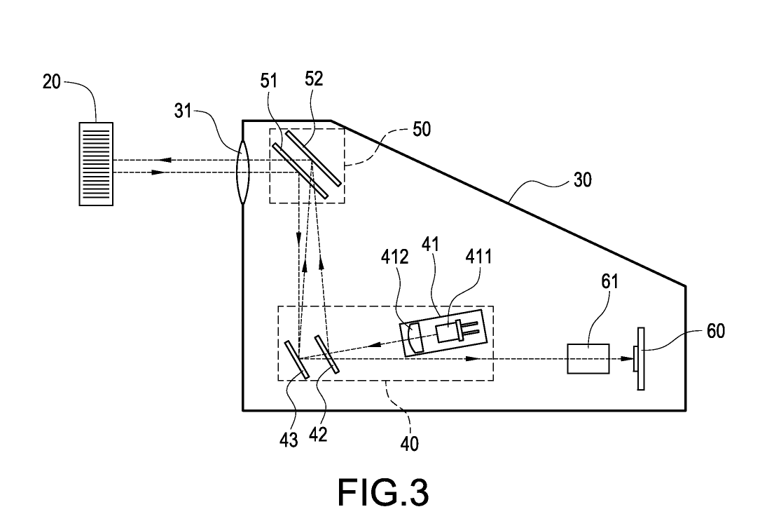

FIG. 3 shows the multiple directional barcode scanner according to an embodiment of the present invention. The multiple directional barcode scanner is used for scanning a barcode 20 as shown. The multiple directional barcode scanner mainly includes a housing 30, a scanning pattern generating unit 40, a scanning pattern multiplying unit 50 and an image sensor 60. It should be mentioned that the scanning pattern generating unit 40 and the scanning pattern multiplying unit 50 constitute a multiple scanning light source for the scanner of the present invention.

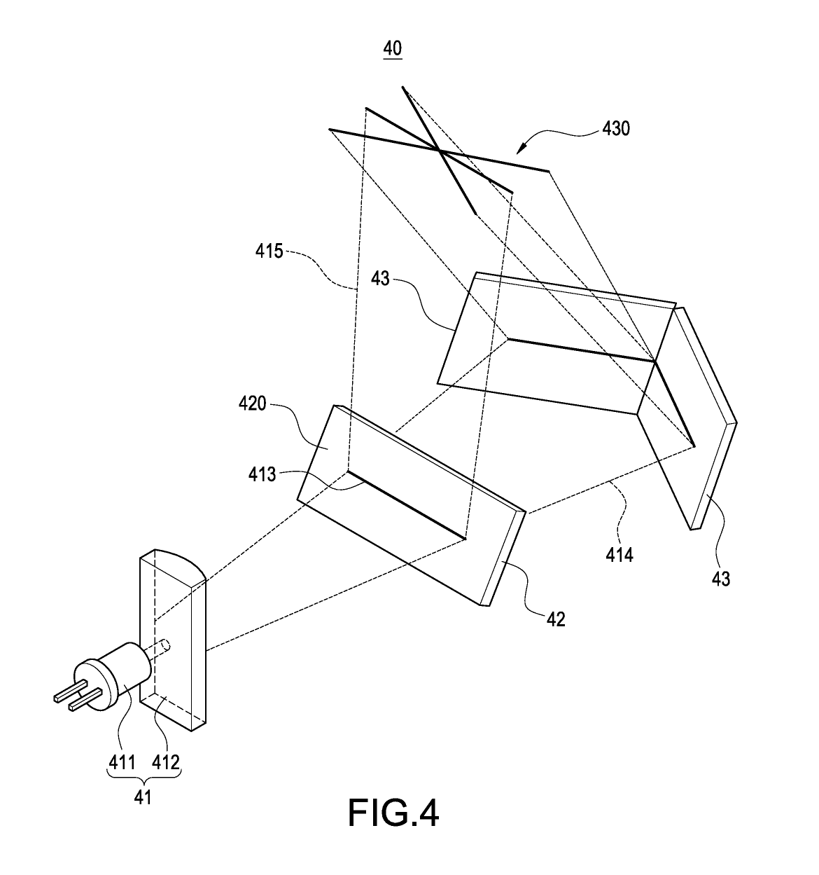

The housing 30 has a window 31 for passing through light beam. The scanning pattern generating unit 40 is used for generating and projecting out a scanning pattern. In this embodiment, as FIG. 4 shows, the scanning pattern generating unit 40 includes a scanning line generator 41, a beamsplitter 42 and two reflectors 43 oblique to the beamsplitter 42. As shown in FIG. 4, the beamsplitter 42 and the two reflectors 43 are arranged in a triangle configuration.

The scanning line generator 41 includes a spot beam laser module 411 and a beam shaper 412 used for changing the beam shape of the laser module 411 from a spot to a line. In this embodiment, the beam shaper 412 is a cylindrical lens, but is not limited thereto in practical use. After passing through the beam shaper 412, the laser beam emitted from the laser module 411 can be transformed from a spot beam into a line-shaped scanning line 413, which is then projected on the a surface 420 of the beamsplitter 42.

The surface 420 of the beamsplitter 42 is oblique to the projecting direction of the scanning line 413. After passing through the beamsplitter 42, the scanning line 413 will be split into a reflecting portion 415 and a transmitting portion 414. The transmitting portion 414 is reflected by the two reflectors 43 and then intersects with the reflecting portion 415 and thus forms the scanning pattern 430 having three scanning lines intersecting with each other. In other words, the beamsplitter 42 and the two reflectors 43 each provides a scanning line to constitute the scanning pattern 430, since the beamsplitter 42 and the two reflectors 43 are arranged in different directions, the scanning pattern 430 can have three scanning lines each has different directions. In practical use, one beamsplitter and only one reflector can be arranged in different directions to provide a scanning pattern which has two scanning lines with different directions.

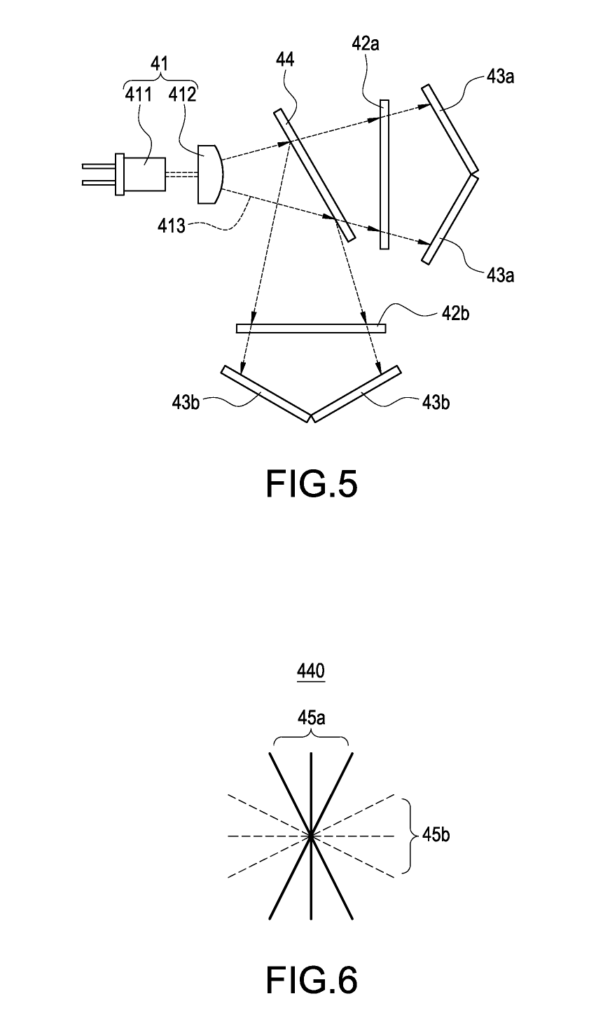

In addition, FIG. 5 shows another embodiment of the scanning pattern generating unit 40. A beamsplitter 44 is provided to split the scanning line 413 into two beams, and two optical sets which each has a beamsplitter and two reflectors are used for receiving the two beams. One of the optical sets at the right side of FIG. 5 has a beamsplitter 42a and two reflectors 43a which are arranged in a triangle configuration. The other one optical set at the lower side of FIG. 5 has a beamsplitter 42b and two reflectors 43b which are also arranged in a triangle configuration. After the optical set at the right side receives the transmitting beam of the scanning line 413 from the beamsplitter 44, the transmitting beam will be further split into a reflecting portion and a transmitting portion. The transmitting portion will be projected onto the reflector 43a, and then reflected by the reflectors 43a and intersects with the reflecting portion and thus forms a scanning line set 45a of the scanning pattern 440 as FIG. 6 shows. Similarly, the optical set at the lower side forms another scanning line set 45b of the scanning pattern 440 in FIG. 6.

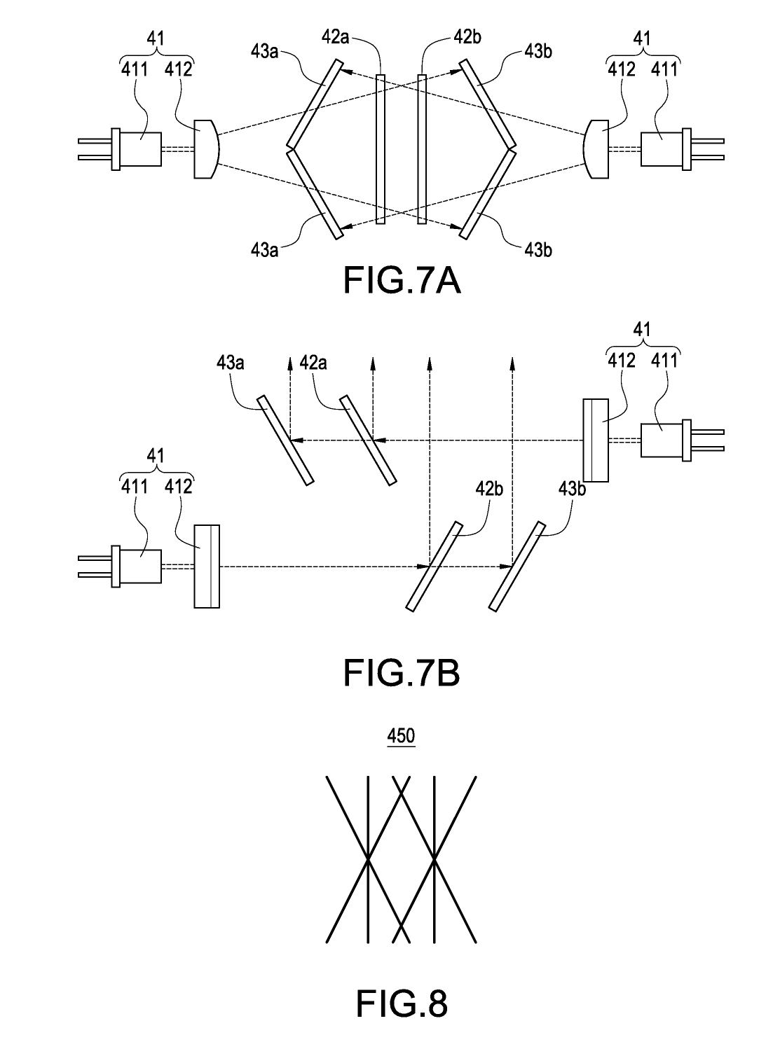

FIG. 7A and FIG. 7B show another embodiment of the scanning pattern generating unit, which includes two sets of the scanning pattern generating units 40 as shown in the FIG. 4, which are arranged face to face from the top view and stacked togather from the side view. That means the scanning pattern generating unit of this embodiment has two optical sets, including beamsplitters 42a, 42b and reflectors 43a, 43b, so as to generate a scanning pattern 450 as shown in FIG. 8, which has two scanning line sets side by side. Each of the scanning line sets has three scanning lines intersecting with each other.

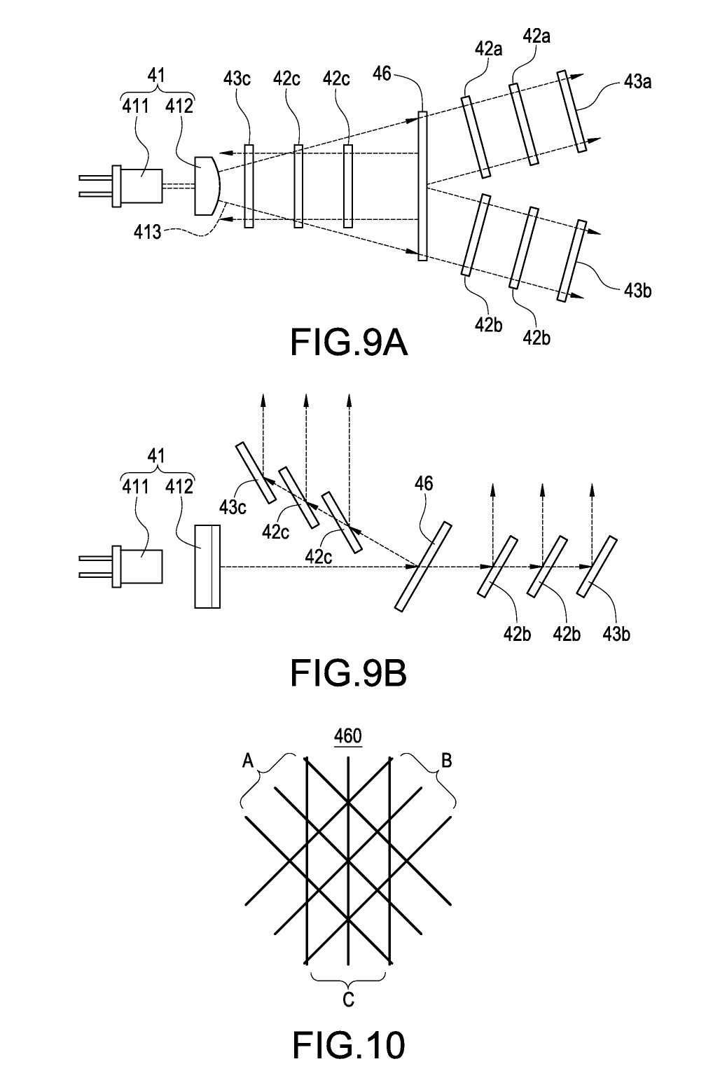

FIG. 9A and FIG. 9B show another embodiment of the scanning pattern generating unit. A beamsplitter 46 is provided to split the scanning line 413 from the scanning line generator 41 into a transmitting portion and a reflecting portion. An optical set including two beamsplitters 42a and a reflector 43a and another optical set including two beamsplitters 42b and a reflector 43b are provided to receive the transmitting portion. An optical set including two beamsplitters 42c and a reflector 43c is provided to receive the reflecting portion. The beamsplitters and reflector in each of the optical sets are substantially parallel to each other. After receiving the reflecting portion from the beamsplitter 46, the optical set at the upper side of FIG. 9B can form a scanning line set C of the scanning pattern 460 as FIG. 10 shows. The scanning line set C has three scanning lines intersecting with each other. Similarly, the optical set at the right side of FIG. 9A can form scanning line sets A and B of the scanning pattern 460. The scanning line sets A and B each has three scanning lines intersecting with each other.

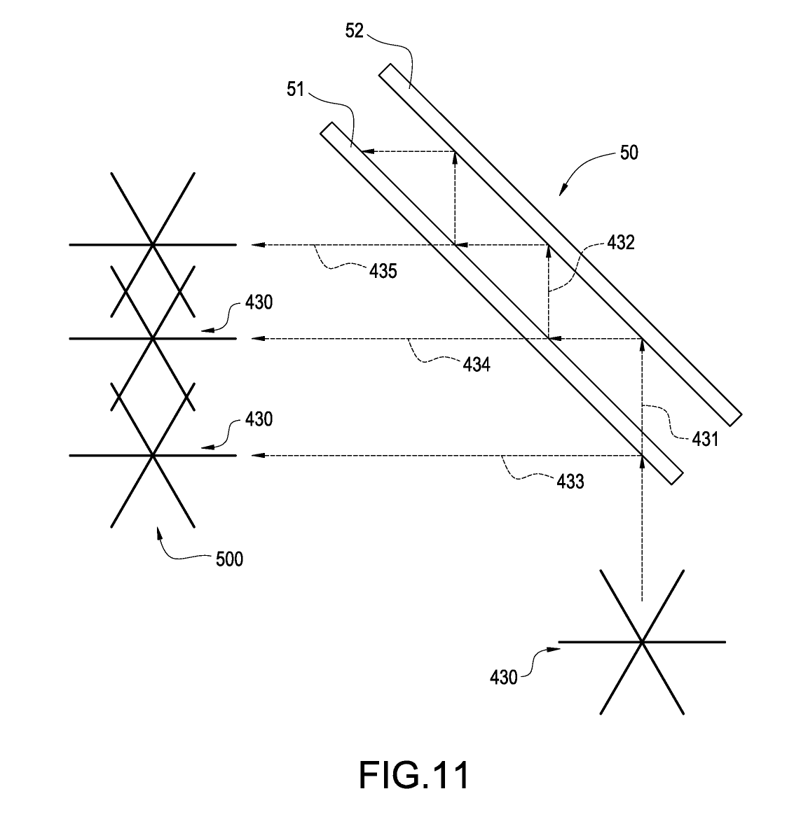

As FIG. 11 shows, the scanning pattern multiplying unit 50 is used for multiplying the scanning pattern from the scanning pattern generating unit 40. The scanning pattern can be anyone of the scanning pattern 430, 440, 450, 460 mentioned above or other else, and is not limited thereto. The scanning pattern adopted below is the scanning pattern 430, for illustration.

The scanning pattern multiplying unit 50 has a beamsplitter 51 and a reflector 52 substantially parallel to the beamsplitter 51. The beamsplitter 51 is oblique to the projection direction of the scanning pattern 430. Therefore, the scanning pattern 430 is multiplied and projected toward a predetermined direction at intervals to form a scanning pattern array. More specifically, after a first splitting of the scanning pattern 430 is performed by the beamsplitter 51, the transmitting portion 431 from the first splitting is reflected back to the beamsplitter 51 by the reflector 52 and to perform a second splitting, and the reflecting portion 432 from the second splitting is reflected back to the beamsplitter 51 by the reflector 52 and to perform a third splitting, and so on. The reflector 52 can reflect back all the beams of scanning pattern 430 from the beamsplitter 51 to perform multiple times of splitting until all the beam energy is depleted.

The detailed process will be described hereinafter in three times of splitting for instance. The reflecting portion 433 of the first splitting and the transmitting portion 434, 435 of the second splitting and the third splitting are projected away at intervals from the beamsplitter 51 and opposite to the reflector 52, and form the scanning pattern array 500. Therefore, the scanning pattern array 500 has three scanning pattern in a row. In practical, more than three times of splitting will happen on the beamsplitter 41, thus more than three scanning patterns will be included in the scanning pattern array 500.

As FIG. 3 shows, when the above mentioned scanning pattern array passes through the windows 31 of the housing 30 and projects onto the barcode 20, the image sensor 60 can capture the image of the barcode through an imaging lens 61 and a plurality of optical components in the scanning pattern multiplying unit 50 and the scanning pattern generating unit 40. A processor (not shown) can be used to identify the information in the image and obtain the price of product.

The multiple directional barcode scanner of the present invention utilizes the scanning pattern generating unit 40 and the scanning pattern multiplying unit 50 to generate the scanning pattern array 500. The scanning pattern array 500 has a plurality of scanning line sets arranged in different directions. Since no rotary or swivel mechanism is needed to move the beam spot to form such a scanning pattern array as usual, the projection will become faster and more directly. Besides, neither motor nor related mechanism will cause unexpected failure of the barcode scanner and thus save the cost. In the other hand, it also makes no noise when operating.

While the invention has been described by means of specific embodiments, numerous modifications and variations could be made thereto by those skilled in the art without departing from the scope and spirit of the invention set forth in the claims.

What is claimed is:

1. A multiple scanning light source for scanner, comprising:
a scanning pattern generating unit for projecting a scanning pattern; and
a scanning pattern multiplying unit having a beamsplitter oblique to the projecting direction of the scanning pattern and a reflector substantially parallel to the beamsplitter,
whereby the scanning pattern is multiplied and projected toward a predetermined direction at intervals to form a scanning pattern array.

2. The multiple scanning light source for scanner as claim 1, wherein after a first splitting of the scanning pattern is performed by the beamsplitter, the transmitting portion from the first splitting is reflected back to the beamsplitter by the reflector and to perform a second splitting, and the reflecting portion from the second splitting is reflected back to the beam splitter by the reflector and to perform a third splitting, and the reflecting portion from the first splitting and the transmitting portions of the second splitting and the third splitting are projected away from the beamsplitter at intervals to form the scanning pattern array.

3. The multiple scanning light source for scanner as claim 1, wherein the scanning pattern generating unit comprises a scanning line generator, at least one beamsplitter and at least one reflector oblique to the beamsplitter, the scanning line generator emits a scanning line which passes through the beamsplitter and splits into a reflecting portion and a transmitting portion, the transmitting portion is then reflected by the reflector and intersects with the reflecting portion and thus forms the scanning pattern having at least two scanning lines intersecting with each other.

4. The multiple scanning light source for scanner as claim 3, wherein the scanning line generator comprising a spot beam laser module and a beam shaper used for changing the spot beam of the laser module to a line-shaped beam.

5. The multiple scanning light source for scanner as claim 3, wherein the scanning pattern generating unit further comprises another one reflector oblique to the beamsplitter and the reflector, the transmitting portion of the scanning line is reflected by the two reflectors and then intersects with the reflecting portion and thus forms the scanning pattern having third scanning lines intersecting with each other.

6. The multiple scanning light source for scanner as claim 4, wherein the beam shaper is a cylindrical lens.

7. A multiple directional barcode scanner for scanning a barcode, comprising:
a scanning pattern generating unit for projecting a scanning pattern;
a scanning pattern multiplying unit having a beamsplitter oblique to the projecting direction of the scanning pattern and a reflector substantially parallel to the beamsplitter, wherein the scanning pattern is multiplied and projected toward the barcode at intervals to form a scanning pattern array on the barcode; and
an image sensor for capturing the image of the barcode.

8. The multiple directional barcode scanner as claim 7, wherein after a first splitting of the scanning pattern is performed by the beamsplitter, the transmitting portion from the first splitting is reflected back to the beamsplitter by the reflector and to perform a second splitting, and the reflecting portion from the second splitting is reflected back to the beam splitter by the reflector and to perform a third splitting, and the reflecting portion from the first splitting and the transmitting portions of the second splitting and the third splitting are projected away from the beamsplitter at intervals to form the scanning pattern array.

9. The multiple directional barcode scanner as claim 7, wherein the scanning pattern generating unit comprises a scanning line generator, at least one beamsplitter and at least one reflector oblique to the beamsplitter, the scanning line generator emits a scanning line which passes through the beamsplitter and splits into a reflecting portion and a transmitting portion, the transmitting portion is then reflected by the reflector and intersects with the reflecting portion and thus forms the scanning pattern having at least two scanning lines intersecting with each other.

10. The multiple directional barcode scanner as claim 9, wherein the scanning line generator comprising a spot beam laser module and a beam shaper used for changing the spot beam of the laser module to a line-shaped beam.

11. The multiple directional barcode scanner as claim 9, wherein the scanning pattern generating unit further comprises another one reflector oblique to the beamsplitter and the reflector, the transmitting portion of the scanning line is reflected by the two reflectors and then intersects with the reflecting portion and thus forms the scanning pattern having third scanning lines intersecting with each other.

12. The multiple directional barcode scanner as claim 10, wherein the beam shaper is a cylindrical lens.
